(19) United States
(12) Patent Application Publication
(10) Pub. No.: US 2010/0225619 A1
(43) Pub. Date: Sep. 9, 2010

(54) INPUT DEVICE

(76) Inventor: Mitsuo Soumi, Miyagi (JP)

Correspondence Address: BIRCH STEWART KOLASCH & BIRCH, PO BOX 747, FALLS CHURCH, VA, 22040-0747, US

(21) Appl. No.: 12/680,449

(22) PCT Filed: Sep. 24, 2008
(86) PCT No.: PCT/JP2008/002640

§ 371 Date: Mar. 26, 2010

(30) Foreign Application Priority Data
Sep. 27, 2007 (JP) 2007-250436

(51) Int. Cl. G06F 3/033

(52) U.S. Cl. 345/184

(57) ABSTRACT

A slide type input device is provided, which can be made thin and which has the operability of a dial type input device.

An input member that simulates a portion of the shape of recesses and protrusions of a dial member is provided in a slot so as to be slidable therein. The lateral edges of the slot are lower than the ends thereof. The input member is urged to a central position by elastic members, and is capable of repeated reciprocal motion.

### TECHNICAL FIELD

The present invention is related to a slide type input device. Particularly, the present invention is related to a slide type input device which is suited for performing operations such as scrolling through the screen of a cellular telephone or the like.

### BACKGROUND ART

Input devices that use rotary dials are often employed in apparatuses that perform operations such as scrolling through screens of cellular telephones (as disclosed in Japanese Unexamined Patent Publication No. 2000-174876). In input devices that use rotary dials, a portion of a dial is exposed at the surface of an apparatus. Operations such as scrolling through a screen are performed by rotating the exposed portion with a finger. The relationship between the operation and the movement of the screen can be intuitively understood, and the input device is easy to operate.

However, cellular telephones, in which the input devices that use rotary dials are employed, are becoming more miniaturized and thinner recently. This trend is expected to continue in the future. Therefore, miniaturized input devices are in demand. The input devices that use rotary dials are operated by touching the portion of a circular dial member, which is exposed to the exterior of an apparatus, with a finger. Meanwhile, the remaining portion of the circular dial member is housed within the main body of the apparatus, and therefore a large amount of space is required within the main body. If the diameter of the dial member is decreased to resolve this issue, a problem arises that the operability of the input device deteriorates. For this reason, there are limits to miniaturization and thinning of this type of input device.

The present invention has been developed in view of the foregoing problems of conventional technology. It is an objective of the present invention to provide a slide type input device that does not occupy a large space within the main body of an apparatus, having the favorable operability of a dial type input device.

### DISCLOSURE OF THE INVENTION

A slide type input device of the present invention that achieves the above objective comprises:

a main body;

an input member which is repeatedly operable in a linearly sliding manner on the main body, for selecting a single target from among a plurality of selection targets; and

elastic members for urging the input member to the central position of its range of sliding motion; characterized by:

the main body having a slot for housing the input member such that it is slidable therein;

the lateral edges of the slot being lower than the ends of the slot;

the input member having a plurality of protrusions which are arranged in the sliding direction thereof;

the plurality of protrusions being provided at intervals such that a finger can simultaneously contact more than one protrusion;

the heights of the protrusions being lower the further they are from the center of the input member; and

the main body and the input member being configured such that a finger contacts the ends of the slot at the ends of the range of sliding motion of the input member.

Here, the “plurality of protrusions which are arranged in the sliding direction” of the input member are protrusions which are provided at appropriate intervals along the sliding direction of the input member, to realize the sensation of a dial member when touched by a finger. The central protrusion has the highest height, and the other protrusions become lower in height the further they are from the center of the input member. The input member can be said to be of a shape which is obtained if a fan shaped portion having a central angle of approximately 60 degrees is cut out from a circular dial member, then cut with a chord. The pitch among recesses and protrusions of dial members are varied, from fine to coarse. Any pitch from among these pitches may be adopted.

The “lateral edges of the slot being lower than the ends of the slot” refers to a shape in which a finger that operates the input member in a sliding motion along the lateral edge contacts the ends of the slot at both ends of the range of sliding motion. Preferably, the lateral edges of the slot are formed as semicircular recesses having their lowest points at the midpoint of the lateral edges where the slots become shallowest. However, the lateral edges may be of any shape as long as all the lateral edges are at positions lower than the ends of the slot.

Here, examples of the “plurality of selection targets” may be a plurality of thumbnail images or photography modes to be selected, which are displayed on the LCD of a digital camera or the like.

Any elastic members may be employed, as long as they urge the input member toward the central position within the range of sliding motion thereof. Specific examples include: rubber; springs; wire springs; and accordion structures made of rubber, which are connected to the input member at both ends in the sliding direction thereof.

In the input device of the present invention, it is preferable for a recess or a protrusion to be provided at a bottom surface or a side surface of the input member; and for a clicking member that engages the recess or the protrusion to be provided on the main body. Examples of the clicking member that engages the recess or the protrusion include plate springs and wire springs.

It is desirable for the input device of the present invention to further comprise: means for detecting that the input member has been held at an edge of the range of its sliding motion for a predetermined amount of time or longer; and means for sequentially selecting from among the plurality of selection targets while the input member is being held at the edge of the range of its sliding motion.

The input device of the present invention may further comprise: a pressing member provided at least a portion of the input member that moves in a direction perpendicular to the sliding motion; an elastic members that urges the pressing member to a predetermined position; and means for detecting that the amount of shift of the pressing member has exceeded a predetermined value. The direction of shifting of the pressing member which is detected may be toward the main body, away from the main body, or a direction in which the input member is collapsed perpendicular to the sliding direction.

According to the input device of the present invention configured as described above, the sliding input member simulates a portion of the shape of recesses and protrusions of a dial. Therefore, the same sensation as that obtained when a finger contacts a dial member is obtained, and the finger gradually contacts the ends of the slot as the input member is slidably moved. Accordingly, the sensation of the finger operating the input member is similar to that which is experienced when rotating a dial, and the same operability as a dial type input device is realized. In addition, the input member is urged toward the central position of the range of sliding motion thereof, and when the finger is separated from the input member, it returns to the central position automatically. Therefore, a sensation equivalent to a continuous sliding operation is enabled, and the same sensation as that which is experienced when continuously rotating a dial is obtained. Because the input device is a slide type input device, a large space for housing the input device is not necessary within the main body. That is, an input device is realized which is easy to operate and capable of being miniaturized and made thin.

Note that a recess or a protrusion may be provided at a bottom surface or a side surface of the input member; and a clicking member that engages the recess or the protrusion may be provided on the main body. In this case, a clicking sensation is obtained each time the input member is slidably moved, and sliding operations can be performed with the same sensation as that which is experienced when rotating a rotating dial with a clicker.

The input device of the present invention may further comprise the means for detecting that the input member has been held at an edge of the range of its sliding motion for a predetermined amount of time or longer. In this case, continuous input while holding the input member in a slid position becomes possible. This eliminates the troublesome operation of repeatedly rotating the dial of a dial type input device, which is inherent to such an input device. In addition, this feature realizes a reduction in the number of times that the input device is operated compared to dial type input devices, thereby imparting superior durability.

The input device of the present invention may further comprise the pressing member; and the means for detecting that the amount of shift of the pressing member has exceeded a predetermined value. In this case, sliding input and pressing input are enabled by a single input device. This feature obviates the need for a finger to move to various buttons and the like, and expedites input operations. In addition, this feature can reduce input mistakes which are caused by pressing buttons other than those that a user intended to press.

### BRIEF DESCRIPTION OF THE DRAWINGS

FIG. 1 is a perspective view that illustrates a photo viewer to which the input device of the present invention has been applied.

FIG. 2 is a perspective view that illustrates an input member according to an embodiment of the present invention.

FIG. 3 is a diagram that illustrates a state prior to a finger operating the input device of the present invention.

FIG. 4 is a diagram that illustrates the movement of a cursor when a sliding operation is performed with the input device of the present invention.

FIG. 5 is a plan view that illustrates an input device according to a second embodiment of the present invention that employs accordion shaped rubber structures as elastic members.

FIG. 6 is a sectional view of the input device of FIG. 5, taken in the X-Y direction.

FIG. 7 is a plan view that illustrates an input member of FIG. 5 in a state in which it is slidably moved in the X direction.

FIG. 8 is a sectional view of the input device of FIG. 7, taken in the X-Y direction.

FIG. 9 is a perspective view that illustrates an input device according to a third embodiment of the present invention, which is provided with a clicking member.

FIG. 10 is a perspective view that illustrates a means for detecting the sliding motion of an input member of an input device according to a fourth embodiment of the present invention.

FIG. 11 is a plan view that illustrates a state in which a conductive member is bridging a pair of conductive rectangles 38 to enable conduction.

FIG. 12 is a sectional view that illustrates an input device according to a fifth embodiment of the present invention that detects the sliding motion of an input member.

FIG. 13 is a sectional view that illustrates an input device according to a sixth embodiment of the present invention that detects that an input member is being held at the ends of the range of sliding motion thereof for a predetermined amount of time.

FIG. 14 is a perspective view of a photo viewer that illustrates an input operation employing the input device of the sixth embodiment.

FIG. 15 is a perspective view of the photo viewer that illustrates a state in which a cursor has been moved through one image by the input operation of FIG. 14.

FIG. 16 is a perspective view of the photo viewer that illustrates a state in which a cursor has been moved through four images by the input operation of FIG. 14.

FIG. 17 is a sectional view that illustrates an input device according to a seventh embodiment of the present invention that detects that a portion of an input member depressed toward a main body.

FIG. 18 is a sectional view that illustrates a state in which a portion of an input member of an input device according to an eighth embodiment of the present invention is pulled away from a main body.

FIG. 19 is a sectional view that illustrates means for detecting that the amount of shift of a portion of the input member has exceeded a predetermined value of the input device according to the eighth embodiment of the present invention, in a state in which the portion of the input member is at a predetermined position.

FIG. 20 is a sectional view that illustrates a state in which a portion of the input member of the input device according to the eighth embodiment of the present invention is pressed toward the main body.

FIG. 21 is a sectional view that illustrates an input device according to a ninth embodiment of the present invention, that incorporates the features of the input devices of the sixth and eighth embodiments.

FIG. 22 is a plan view that illustrates an input device according to a tenth embodiment of the present invention which is equipped with means for performing input by collapsing at least a portion of an input member toward the lateral edges of a slot.

### BEST MODE FOR CARRYING OUT THE INVENTION

Hereinafter, embodiments of the present invention will be described with reference to the attached drawings.

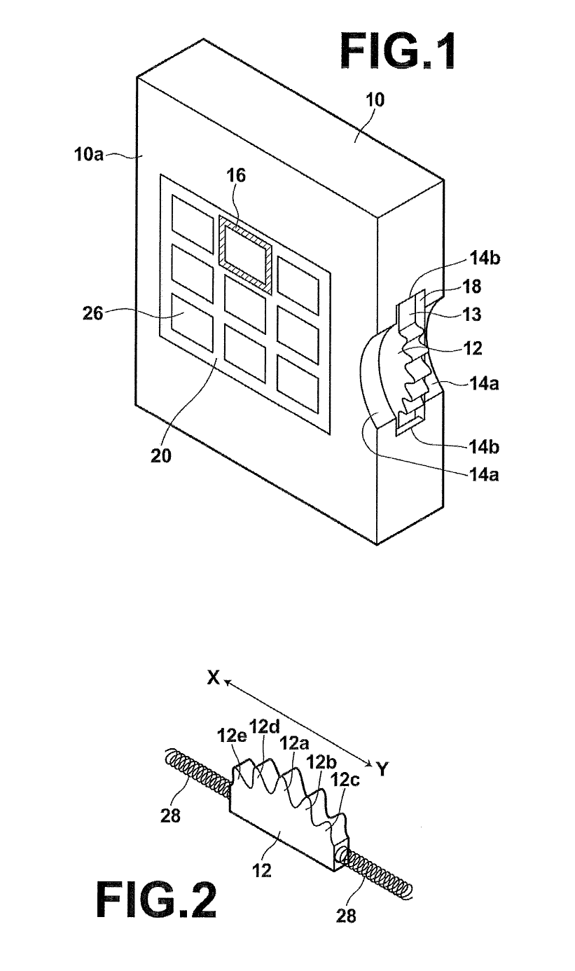

FIG. 1 is a perspective view of a photo viewer to which the input device of the present invention has been applied.

A liquid crystal display 20 is provided on a front surface 10a of the main body 10 of the photo viewer. Thumbnail images 26 may be displayed arranged in a 3×3 fashion along with a cursor 16 for selecting from among the thumbnail images 26 on the liquid crystal display 20, for example. The input device is provided on the side surface of the main body 10 of the photo viewer as a switch to perform input operations for moving the cursor 16 to a desired thumbnail image. The input device is constituted by: a slot 18 having lateral edges 14a which are more recessed than the ends 14b thereof; an input member 12; springs (not shown, refer to FIG. 2) that urge the input member 12 to the central position of its range of sliding motion; and means for detecting sliding operations of the input member 12 (to be described later). The slot 18 is a rectangular recess when viewed from above, and the lateral edges 14a that form the walls of the slot are recesses in a portion of the side wall of the main body 10. The lateral edges 14a are of a recessed shape that cause the slot 18 to become shallow at the midpoint in the longitudinal direction thereof. Thereby, the slot 18 becomes shallowest at the midpoint in the longitudinal direction thereof. The input member 12 is provided within the slot 18 so as to be slidable therein, and input operations are performed by sliding the input member 12. The dimensions of the side wall of the photo viewer are approximately 7 cm high and 2 cm wide and the dimensions of the slot 18 are approximately 5 cm high and 1 cm wide, for example. The depth of the slot 18 varies from approximately 0.5 cm to 1 cm due to the recessed lateral edges 14a thereof. The dimensions of the bottom surface of the input member 12 housed within the slot 18 are approximately 3 cm high and 0.7 cm wide. The sizes of the slot and the input member may be changed as desired, according to the electronic device in which they are employed.

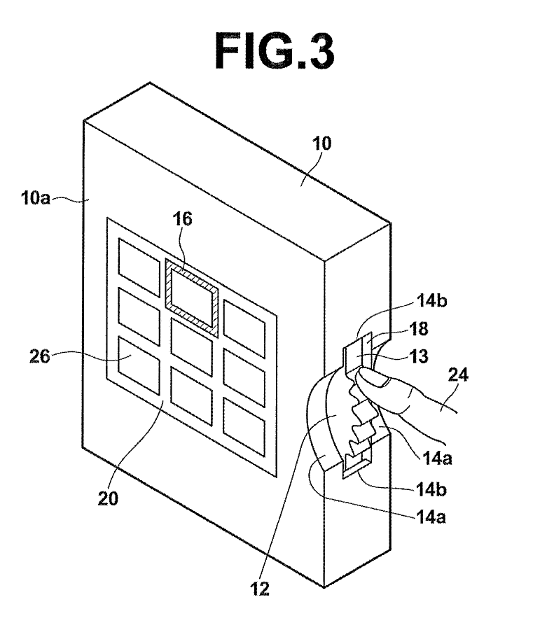

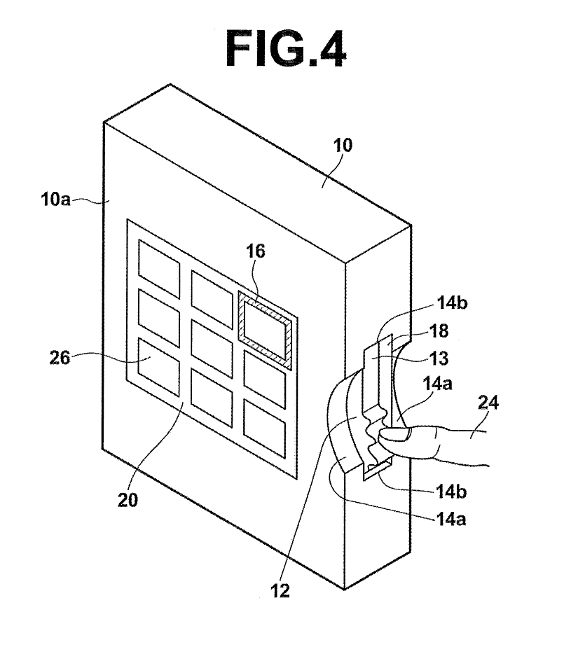

FIG. 2 is a magnified view that illustrates the input member 12 in detail. The surface of the input member 12 opposite the surface which is installed in the main body 10, that is, the surface which is touched and operated by a finger, is provided with a plurality of protrusions 12a, 12b, 12c, 12d, and 12e. The heights of the protrusions are 0.9 cm, 0.8 cm, 0.7 cm, 0.8 cm, and 0.7 cm, respectively. That is, the height of the center protrusion 12a is the greatest, the heights of the protrusions 12b and 12d, which are adjacent to the center protrusion 12a, are the second highest, and the heights of the protrusions 12b and 12e, which are at the ends of the input member 12, are the lowest. The distances between the peaks of the protrusions are approximately 0.6 cm. Therefore, a finger contacts a plurality of protrusions simultaneously. That is, the shape of the input member 12 approximates that of a portion of the recesses and protrusions of a dial. Hereinafter, it is assumed that the portion of the input member 12 which is contacted by a finger and operated has this shape of recesses and protrusions, unless otherwise specified. Two compression springs 28, 28 are connected to the both ends of the input member 12, in the sliding direction thereof. The compression springs 28 are connected to the input member 12 by their ends abutting the input member 12. The other ends of the springs 28, 28 are fixed to portions of the main body 10. The springs 28, 28 enable movement of the input member 12 in the X-Y direction, and urge the input member 12 toward the central position of the range of sliding motion thereof. Note that although omitted from FIG. 2, covers 13 are provided to hide the springs 28, 28 from view. The covers 13 are visible in FIG. 1, FIG. 3, and FIG. 4.

FIG. 3 and FIG. 4 are diagrams that illustrate how the input member 12 of the photo viewer is slidably moved and operated. The cursor 16 is moved when a finger 24 slides the input member 12 to the edge of the range of sliding motion thereof. For example, if the finger 24 slides the input member 12 toward the bottom surface of the main body 10, that is, the downward direction in FIG. 3 and FIG. 4, the input member 12 moves linearly along the slot 18 while the finger 24 moves along the lateral edges 14a of the slot 18. At first, the recessed lateral edges 14a become deeper, and therefore the finger 24 comes out of contact with the lateral edges 14a. When the finger 24 continues to slide the input member 14, the depth of the recesses of the main body 10 that form the lateral edges 14a become shallower. Accompanying the decrease in the depth of the recesses, the depth of the slot 18 with respect to the height of the protrusions of the input member 12 becomes deeper. Therefore, the finger comes into contact with the lower end 14b and the lateral edges 14a at a position in the vicinity of the lower end 14b. When the input member 12 is slidably moved in this manner and the center protrusion 12a reaches the position of the end 14b, the input member 12 is prevented from moving any further in this direction, that is, it is at the end of the range of sliding motion thereof. This sliding operation causes the cursor 16 to select a thumbnail image 26 to the right of the originally selected thumbnail image 26. When the finger disengages the input member 12 here, the input member 12 is returned to the central position of the range of sliding motion thereof by the springs 28, 28. If the input member 12 is slidably moved to the end of the range of sliding motion thereof toward the upper portion of the main body 10, that is, the upward direction in FIG. 3 and FIG. 4, the cursor 16 selects the thumbnail image 26 to the left of the currently selected thumbnail image 26. If the input member 12 is operated to slide toward the lower end of the range of sliding motion thereof again while the rightmost thumbnail image 26 is selected, the cursor 16 selects the leftmost thumbnail image 26 in the row beneath that of the currently selected thumbnail image 28. The cursor 16 can be moved to select a desired image by performing sliding operations in this manner.

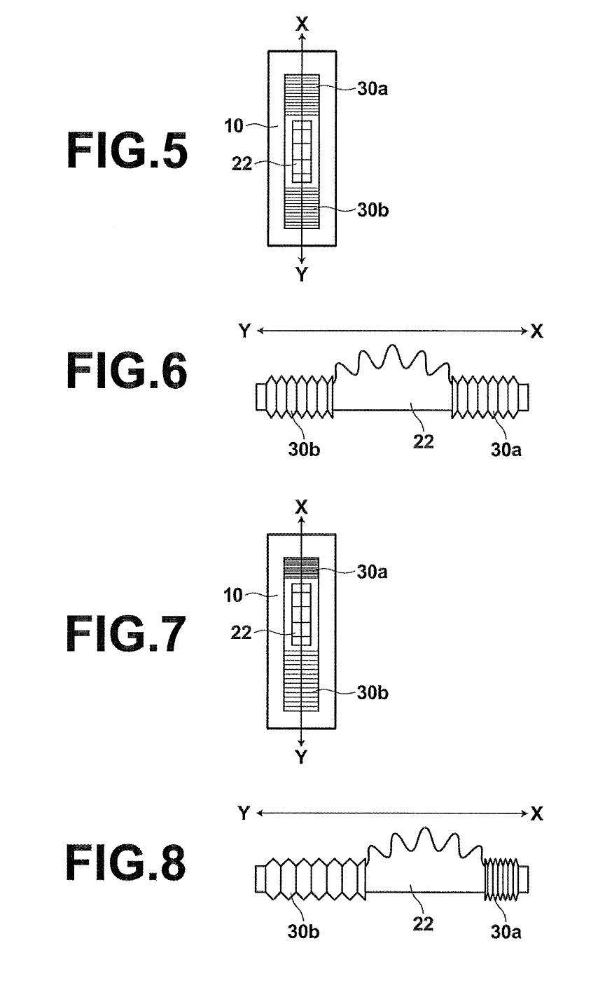

FIG. 5 is a plan view that illustrates an input device according to a second embodiment of the present invention. In the input device of the second embodiment, accordion shaped rubber structures are utilized instead of the springs 28, 28. The accordion shaped rubber structures 30a, 30b are connected to an input member 22 by their ends abutting the input member 12. The other ends of the accordion shaped rubber structures 30a, 30b are connected to portions of the main body 10. FIG. 6 is a sectional view of the input device of FIG. 5, taken in the X-Y direction. The accordion shaped rubber structures 30a, 30b enable movement of the input member 22 in the X-Y direction, and urge the input member 22 toward the central position of the range of sliding motion thereof.

FIG. 7 is a plan view that illustrates the input member 22 in a state in which it is slidably moved in the X direction. FIG. 8 is a sectional view of the input device of FIG. 7, taken in the X-Y direction. Due to this sliding operation, the accordion shaped rubber structure 30a on the side of input member 22 toward the X direction is compressed, and conversely the accordion shaped rubber structure 30b on the side of the input member 22 toward the Y direction is stretched. Thereby, the input member 22 returns to its original position when the finger disengages the input member 22.

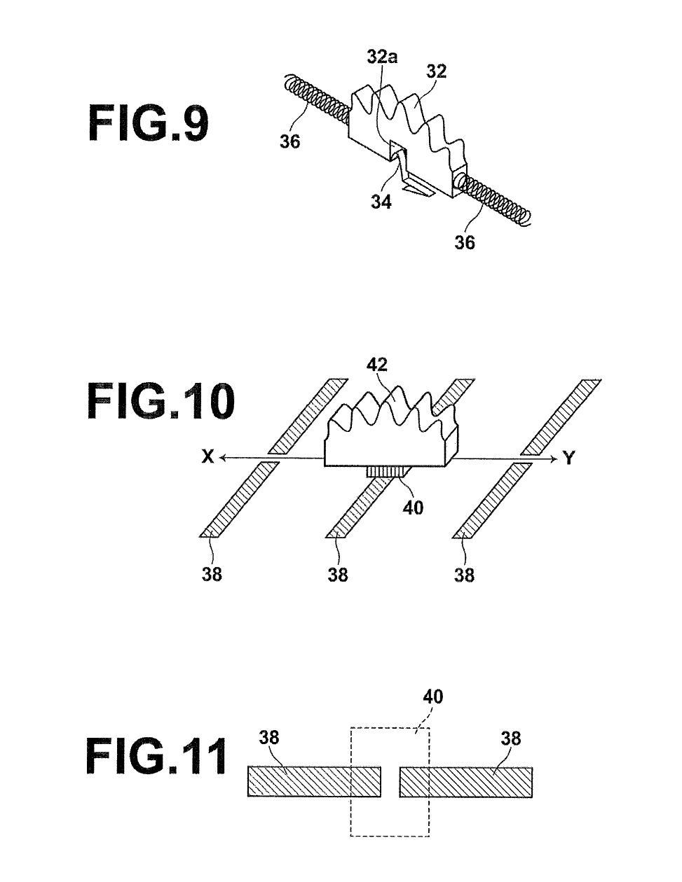

FIG. 9 is a perspective view that illustrates an input device according to a third embodiment of the present invention. In the input device of the third embodiment, a recess 32a is provided in the bottom surface of an input member 32 and a clicking member is provided on a main body. A plate spring 34, which is the clicking member is provided at a position that interferes with the recess 32a provided in the bottom surface of the input member 32. The plate spring 34 engages the recess 32a in the bottom surface of the input member 32 when the input member 32 is slidably moved, and adds resistance to the sliding motion. Thereby, a clicking sensation is added to the sliding motion of the input member 32.

In the following examples, springs which are connected to the ends of input members at the ends in the sliding directions thereof are omitted, to simplify the drawings.

FIG. 10 is a perspective view that illustrates a means for detecting the sliding motion of an input member 42 of an input device according to a fourth embodiment of the present invention. A conductive pattern is formed by six conductive rectangles 38 that have longitudinal axes in a direction perpendicular to the sliding direction of the input member 42. The six conductive rectangles 38 are not in contact each other. A pair of the conductive rectangles 38 having edges in proximity to each other is provided at the vicinities of the ends and the central position of the range of sliding motion of the input member 42. That is, the pairs of conductive rectangles 38 are provided at a total of three locations. A conductive member 40 is provided on the bottom surface of the input member 42. The conductive member 40 bridges the gaps between each pair of conductive rectangles 38. The sliding direction of the input member 42 is a direction along the edges of the conductive rectangles 38 which are in proximity to each other. As the position of the input member 42 is changed by sliding, the edges of one of the pairs of conductive rectangles 38 are bridged by the conductive member 40, to enable conduction. FIG. 11 is a plan view that illustrates a state in which the conductive member 40 is bridging a pair of the conductive rectangles 38. In FIG. 11, the conductive member 40 of the input member 42 is illustrated by broken lines. FIG. 10 illustrates a state in which the input member 42 is at the central position in the longitudinal direction of the slot 18. When the input member 42 is moved in one of the sliding directions, the conductive member 40 which had been bridging the pair of conductive rectangles 38 separates from the conductive rectangles 38, and conduction is temporarily interrupted. When the input member 42 is moved further in the same direction, the conductive member 40 contacts the next pair of conductive rectangles 38, to enable conduction. The pairs of conductive rectangles 38 generate different signal when conduction is enabled depending on their position. Therefore, the direction in which the input member 42 is slidably moved can be discriminated. The shapes and positions of the conductive member 40 and the conductive pattern 38 are not limited to those described above, as long as conductive states vary according to the position of the input member 42.

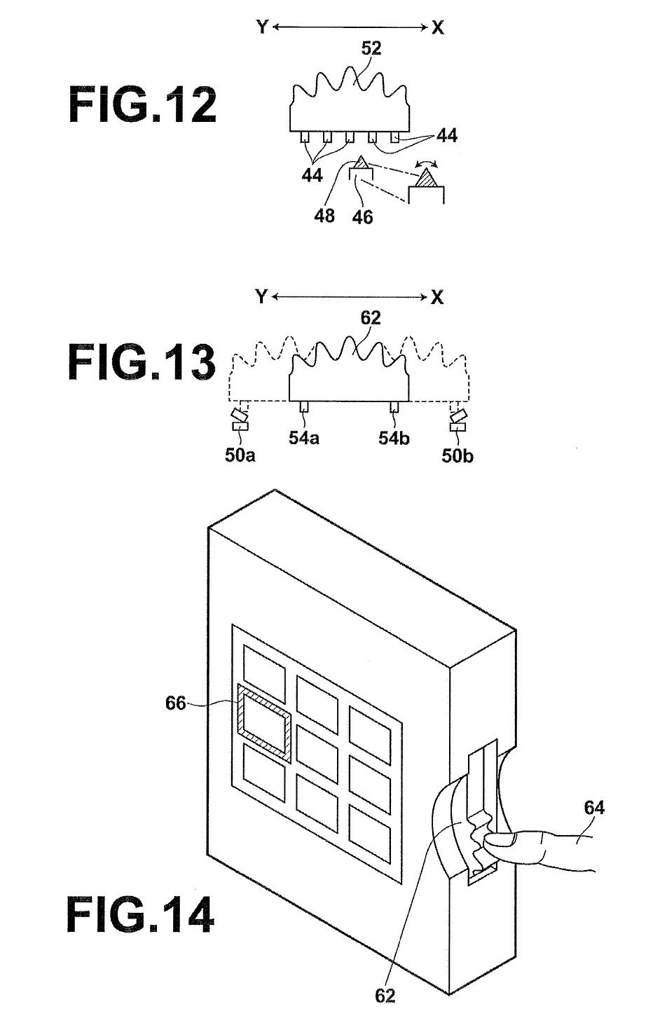

FIG. 12 is a sectional view that illustrates an input device according to a fifth embodiment of the present invention. The input device of the fifth embodiment employs a different means for detecting sliding motion from that of the fourth embodiment. Collapsible lever type switches 46 are provided in the main body 10, in which an input member 52 is installed. A collapsible lever 48 of the collapsible lever type switch 46 is provided toward the side of the input member 52, and is movable in the sliding direction X-Y. A plurality of ribs 44 are formed on the bottom surface of the input member 52, with intervals therebetween which are wide enough to accommodate the collapsible lever 48. When the input member 52 is at the central position in the range of sliding motion thereof, the collapsible lever 48 is at a position between the ribs. When the input member 52 is slidingly moved in the X-Y direction, the ribs 44 on the bottom surface of the input member 52 cause the collapsible lever 48 to collapse, causing signals to be generated from the collapsible lever type switch 46. Different signals are generated when the collapsible lever 48 collapses in the X direction and the Y direction, and therefore the direction in which the input member 45 has been slidably moved can be discriminated. Here, the ribs 44 and the collapsible lever 48 are provided toward the bottom of the input member 52. Alternatively, the ribs and the collapsible lever may be provided toward one of the side surfaces of the input member. Note that the portion of FIG. 12 which is drawn out by broken lines is a magnified view that illustrates the movement of the collapsible lever type switch 46.

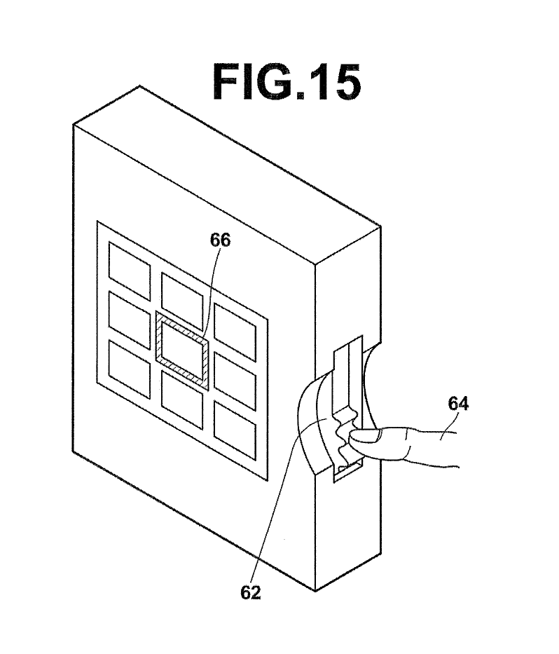

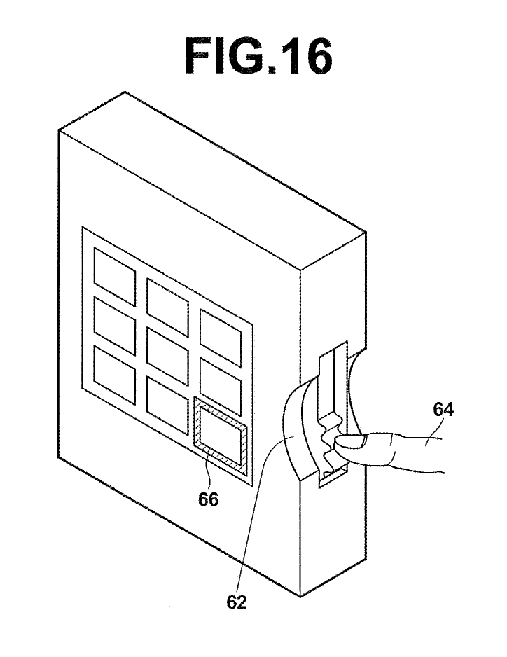

FIG. 13 is a sectional view that illustrates an input device according to a sixth embodiment of the present invention. The input device of the sixth embodiment detects that an input member 62 is being held at the ends of the range of sliding motion thereof for a predetermined amount of time. Detecting switches 50a, 50b are provided in the vicinities of the two ends of the range of sliding motion of the input member 62. Ribs 54a, 54b are provided on the bottom surface of the input member 62 at the two ends in the sliding direction thereof. When the input member 62 is slidingly moved to the end of the range of sliding motion thereof, the rib 54a or the rib 54b at the end in the direction of the sliding motion depresses the detecting switch 50a or 50b corresponding thereto. For example, if the input member 62 is moved to the end of the range of sliding motion in the X direction and held there, the rib 54b continues to press the detecting switch 50b. Signals that indicate that input corresponding to one of the sliding direction is being continuously performed are generated by the detecting switches 50a, 50b. Therefore, a cursor is sequentially and continuously moved, as will be illustrated in FIG. 14, FIG. 15, and FIG. 16 described below. Here, the ribs 54a, 54b and the detecting switches 54a, 54b are provided toward the bottom of the input member 62. Alternatively, the ribs and the detecting switches may be provided toward one of the side surfaces of the input member.

FIG. 14, FIG. 15, and FIG. 16 illustrate a photo viewer to which the input device according to the sixth embodiment of the present invention is applied. The input device of the sixth embodiment detects that the input member 62 is being held at the ends of the range of sliding motion thereof for a predetermined amount of time. Input operations and the movement of a cursor 66 will be described in detail. The photo viewer is assumed to be the same as the photo viewer of FIG. 1, except for the input member and the detecting switches. In FIG. 14, a finger 64 holds the input member 62 at the end of the range of sliding motion thereof toward the lower end of the drawing. Thereby, the cursor 66 sequentially selects thumbnail images to the right of previously selected thumbnail images. When the cursor 66 reaches the rightmost image in a row and the holding operation is continued, the cursor 66 selects the leftmost thumbnail in the row under the row of the previously selected thumbnail image. Thereafter, the cursor 66 continues to sequentially select thumbnail images to the right of previously selected thumbnail images. FIG. 16 illustrates the photo viewer, in which the cursor 66 has been moved to select a thumbnail image four images beyond that which is selected in FIG. 15, by continuing to hold the input member 62 at the end of the range of sliding motion thereof. In FIG. 16, the cursor 66, which had been selecting the center thumbnail image moves through four thumbnail images as described above, to select the rightmost thumbnail image in the bottom row. As described above, it is not necessary to repeat sliding operations a plurality of times, even if a desired image is at a position remote from a currently selected image.

FIG. 17 is a sectional view that illustrates an input device according to a seventh embodiment of the present invention. In the input device of the seventh embodiment, a portion of an input member 72 is capable of being depressed toward a main body. The shape of the input member 72 is similar to the input member 12 illustrated in FIG. 2, except that a center protrusion corresponding to the protrusion 12a is not present. A center button is provided instead of the center protrusion 12a. The center button is constituted by a protrusion 100a shaped similar to the protrusion 12a, and a cylindrical portion 100b having a smaller diameter than the protrusion 100a. The protrusion 100a faces the side of the input member 72 which is contacted by fingers, such that the input member 72 as a whole is shaped as a portion of a dial. The cylindrical portion 100b penetrates through the input member 72 toward the main body. The cylindrical portion 100b is sufficiently long to penetrate through the input member 72. A spring 102 having a diameter smaller than that of the protrusion 100a and greater than that of the cylindrical portion 100b is provided between the center button and the input member 72. The spring 102 urges the protrusion 100a of the center button to a position higher than the other protrusions, and at which the cylindrical portion 100b does not depress a detecting switch 104, to be described later. The detecting switch 104 is provided on a substrate 106 in the main body facing the cylindrical portion 100b, at a position in the direction in which the cylindrical portion 100b extends. By pressing the center button toward the detecting switch 104, the cylindrical portion 100b depresses the detecting switch 104, and the detecting switch generates a signal. When pressing of the center button is ceased, the center button is returned to its original position by the spring 102. The button need not necessarily be provided in the center of the input member 72, and any portion of the input member 72 may be caused to move toward the main body. The position of the detecting switch 104 is also not limited to that described above, and may be in any position as long as it is depressed when the button is depressed. The spring 102 that urges the center button to the predetermined position is not limited to being a spring. Alternatively, a rubber member may be employed. When it is detected that the detecting switch 104 of FIG. 17 has been depressed, it may be judged that selection of a thumbnail image by a cursor is finalized, and the image may be displayed in full size, for example.

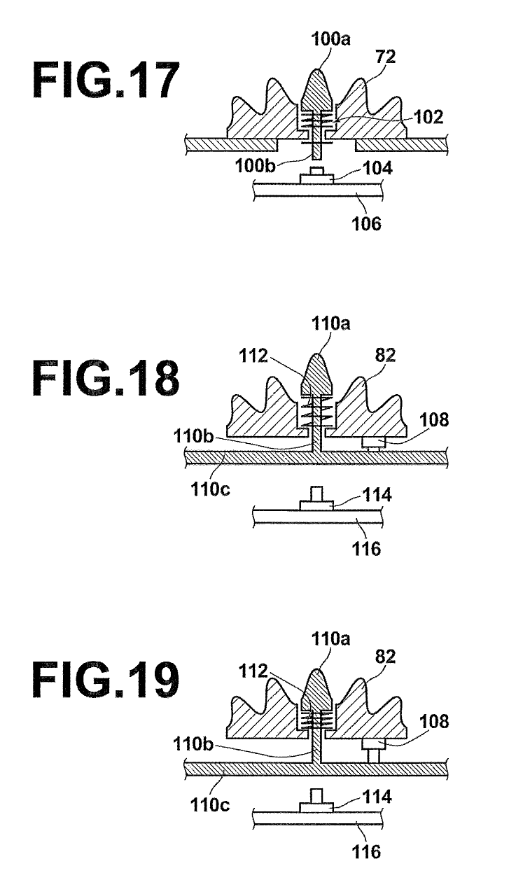

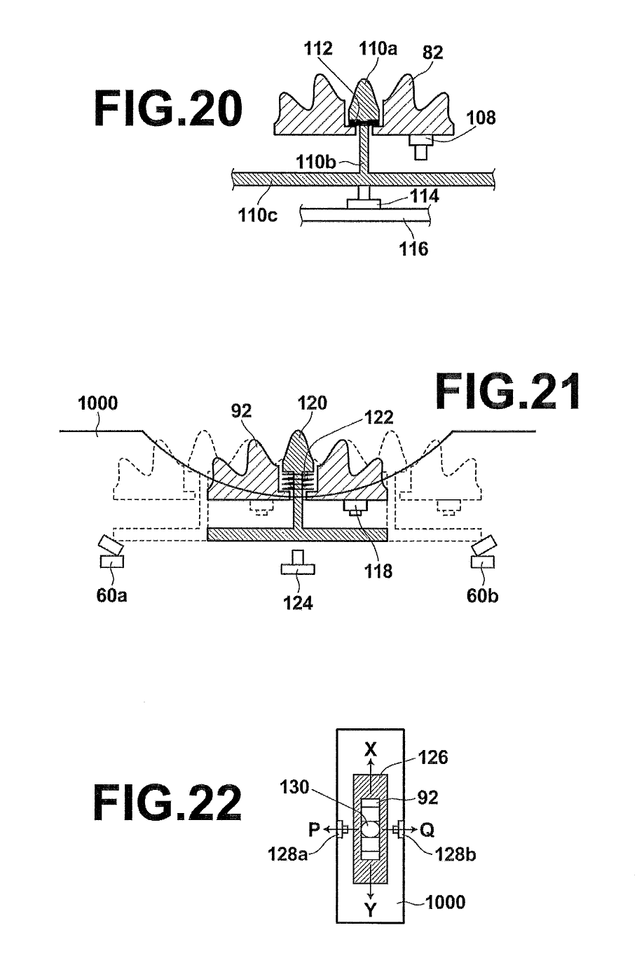

FIG. 18, FIG. 19, and FIG. 20 are sectional views that illustrate an input device according to an eighth embodiment of the present invention. The input device of the eight embodiment is equipped with means for detecting that the amount of shift when an input member 82 is pressed toward or pulled away from a main body has exceeded a predetermined value. The input member 82 is of the same structure as the input member 72 of FIG. 17. A center button of the eighth embodiment is constituted by: a protrusion 110a and a cylindrical portion 110b similar to those of the center button illustrated in FIG. 17; and a bottom portion 110c which is connected to the end of the cylindrical portion 110b opposite that at which the protrusion 110a is connected. The bottom portion 110c extends along the bottom surface of the input member 82, and is of an appropriate thickness. The center button of the eighth embodiment resembles an inverted “T” shape in cross section. A spring 112 that urges the protrusion 110a of the center button to a position higher than the other protrusions and at which no detecting switches are depressed, is provided between the input member 82 and the center button, similarly to the input device of FIG. 17. A substrate 116 and a detecting switch 114 are provided in a manner similar to those of FIG. 17. Further, a detecting switch 108 is provided on the bottom surface of the input member 82, facing the bottom portion 110c of the center button. When the center button is pulled in a direction away from the main body, the detecting switch 108 is depressed by being sandwiched between the bottom portion 110c of the center button and the bottom surface of the input member 82, as illustrated in FIG. 18. When the center button is pressed toward the main body, the detecting switch 114 is depressed by the bottom portion 110c of the center button, as illustrated in FIG. 20. When a finger disengages the center button, the center button is returned to its original position by the spring 112. In this matter, the amount of shift of the center button exceeding a predetermined value is detected by the detecting switch 108 when the center button is pressed toward the main body and pulled away from the main body. ON/OFF switching of the detecting switch 108 is detected before ON/OFF switching of the detecting switch 114, enabling two step detection of electrical input. Thereby, a halfway depressed state of the center button can be detected. The halfway depressed state may cause a thumbnail image which is selected by a cursor to become highlighted or magnified, to enable confirmation regarding whether the thumbnail image is a desired image, for example.

FIG. 21 is a sectional view that illustrates an input device according to a ninth embodiment of the present invention. The input device of the ninth embodiment is capable of performing the input performed by the input device of the sixth embodiment illustrated in FIG. 13 and the input device of the eighth embodiment illustrated in FIGS. 18 through 20. An input member 92, which is the same as the input member 82 of FIG. 19, is urged toward the central position within the range of sliding motion thereof within a slot by springs (not shown). Detecting switches 60a, 60b are provided in the vicinities of the two ends of the range of sliding motion of the input member 92, in the same manner as in the input device of FIG. 13. By adopting this configuration, the manner of input described with reference to FIGS. 18 through 20 is realized. In addition, the when the input member 92 is slidingly moved to the ends of the range of sliding motion thereof, a bottom portion of the center button depresses the detecting switch 60a or 60b. Therefore, the advantageous effects obtained by the input device of the sixth embodiment illustrated in FIG. 13 and the advantageous effects obtained by the input device of the eighth embodiment illustrated in FIG. 19 are both obtained. That is, multiple types of input, such as sliding the input member 92 then holding it for a predetermined amount of time, and depressing a portion of the input member 92 halfway and completely, are enabled.

FIG. 22 is a plan view that illustrates an input device according to a tenth embodiment of the present invention. The input device of the tenth embodiment is the input device illustrated in FIG. 21, further equipped with means for performing input by collapsing the input member 92 toward the lateral edges of a slot 126. Here, detecting switches 128a, 128b are provided on the lateral edges of the slot 126 at both sides of a center button 130. The input member 92 has sufficient space, that is, play, to enable the center button 130 to be collapsed in a P directions P and a Q direction, toward the lateral edges. The detecting switch 128a or the detecting switch 128b is depressed by collapsing the center button in the P direction or the Q direction. Depression of the detection switch 128a and the detecting switch 128b are detected, and a signal is generated. Thereby, even more different types of input can be performed by the input member 92. Opening a menu window and closing a menu window during multiple image display are examples of the manner in which the additional types of input may be.

### FIELD OF INDUSTRIAL APPLICABILITY

The present invention is suited for use as an operating button for cellular telephones, an operating button for digital cameras, and other miniature electric devices, such as personal computers. The present invention may also be utilized as an input device for various household appliances.

1-5. (canceled)

6. An input device, comprising:
a main body;
an input member which is repeatedly operable in a linearly sliding manner on the main body, for selecting a single target from among a plurality of selection targets; and
elastic members for urging the input member to the central position of its range of sliding motion;
the main body having a slot for housing the input member such that it is slidable therein;
the lateral edges of the slot being lower than the ends of the slot;
the input member having a plurality of protrusions which are arranged in the sliding direction thereof;
the plurality of protrusions being provided at intervals such that a finger can simultaneously contact more than one protrusion;
the heights of the protrusions being lower the further they are from the center of the input member; and
the main body and the input member being configured such that a finger contacts the ends of the slot at the ends of the range of sliding motion of the input member.

7. An input device as defined in claim 6, wherein:
the elastic members are accordion structures made of rubber which are connected to the input member at at least both ends in the sliding direction thereof.

8. An input device as defined in claim 6, further comprising:
a recess or a protrusion provided at a bottom surface or a side surface of the input member; and
a clicking member that engages the recess or the protrusion, provided on the main body.

9. An input device as defined in claim 6, further comprising:
means for detecting that the input member has been held at an edge of the range of its sliding motion for a predetermined amount of time or longer; and
means for sequentially selecting from among the plurality of selection targets while the input member is being held at the edge of the range of its sliding motion.

10. An input device as defined in claim 6, further comprising:
a pressing member provided at at least a portion of the input member that moves in a direction perpendicular to the sliding direction;
an elastic member that urges the pressing member to a predetermined position; and
means for detecting that the amount of shift of the pressing member has exceeded a predetermined value.
